(19) United States
(12) Patent Application Publication
(10) Pub. No.: US 2017/0331267 A1
(43) Pub. Date: Nov. 16, 2017

(54) APPARATUS AND PROCESS FOR CONSTRUCTING A CABLE HARNESS

(71) Applicant: Bentek Corporation, San Jose, CA (US)

(72) Inventors: Wesley DELAP, San Jose, CA (US); Vu TRAN, San Jose, CA (US); Sau VO, San Jose, CA (US)

(21) Appl. No.: 15/493,728

(22) Filed: Apr. 21, 2017

Related U.S. Application Data
(60) Provisional application No. 62/336,444, filed on May 13, 2016.

(51) Int. Cl. H02G 11/00; H02S 40/36; H02S 40/34; H02S 40/44; H02G 1/06

(52) U.S. Cl. CPC H02G 11/006; H02S 40/36; H02S 40/34; H02G 1/06; H02G 2200/20; H02S 40/44

(57) ABSTRACT

Embodiments disclosed herein enable assembly of a solar power cable harness to be completed in a more consistent and efficient manner than known methods of assembly.

### BACKGROUND

Power systems frequently generate and distribute power in the form of electricity from one or more power sources to end users, sometimes via a power distribution grid. For example, fossil fuel or nuclear power sources may generate and deliver electrical power to a distribution system, which distributes electricity via power lines constituting a grid to, e.g., residential or commercial end users. Solar power may be used similarly to generate and distribute electricity. Solar-sourced electricity commonly supplements fossil fuel- or nuclear power-sourced electricity, although in some applications solar power may be the sole source of electricity at the end user.

A power system can be said to include a power generator and a “balance of system” (BOS) comprising all components used to modify, distribute, and ultimately deliver electricity generated from the energy source to the end user. For example, in a fossil-fuel- or nuclear-sourced power system, the BOS includes such components as power lines and other cabling, insulators, connectors, etc. In a solar or photovoltaic (PV) power system, the BOS includes such components as cabling, switches, enclosures, inverters, etc.

In a power distribution system, electrical cables conduct electricity between successive electrical components. For example, in some fossil-fuel-sourced power distribution systems, distribution lines carry electricity from substations to distribution transformers and from the transformers to customers. In a PV system, solar power cables connect solar panels to combiners, combiners to recombiners, combiners to inverters, etc. Electrical cables should be resistant to environmental conditions including ultraviolet radiation, temperature extremes, chemicals, and moisture, to name but four.

There are a variety of industrial and commercial equipment that require the use of cable to transmit electricity, data and other matter. To fit the particular application, these cables may be measured and cut to specified lengths, labeled, bundled together as groups of cables, per specifications, have connectors applied, and be packaged, often in a circular form, either on a spool or in other packaging. The finished product is commonly called a cable harness.

### SUMMARY

In some embodiments, a method for assembling a cable harness comprises pulling one or more cables from a cable source by a turning spool, cutting each of the pulled cables at a desired length, labeling each of the cables, coiling the cables, and applying a respective connector to at least one end of at least one cable in the coil.

In some embodiments, a method for facilitating a solar electricity installation comprises producing a cable harness, including pulling one or more solar power cables from a cable source by a turning spool, cutting each of the pulled solar power cables at a desired length, labeling each of the solar power cables, coiling the solar power cables suitably for the cable harness, and applying a respective connector to at least one end of at least one of the solar power cables in the coil.

In some embodiments, a solar electricity cable harness assembler comprises a solar power cable supply station, one or more counters, a coiling station positioned to pull the solar power cables via the one or more counters and coil the solar power cables downstream from the first and second guides in a single coil suitable for a solar power cable harness; a cutting station positioned for cutting each of the pulled solar power cables at a desired length indicated by the one or more counters, and a binding station before the coiling station, at which the solar power cables are bound before coiling such that the coiling station creates the single coil of the bound solar power cables.

Embodiments disclosed herein enable assembly of a solar power cable harness to be completed in a more consistent and efficient manner than known methods of assembly and, further, promote the physical well-being of assembly personnel through improved ergonomics.

### BRIEF DESCRIPTION OF THE DRAWINGS

The accompanying drawings are considered illustrative of inventive concepts described throughout the disclosure. To the extent that the drawings show inventive concepts, possibly including analysis that is properly considered to be inventive activity, the drawings nevertheless are illustrative in nature and should not be considered unduly limitative in any way.

FIG. 1 illustrates an example of a solar power system.

FIG. 2 illustrates an example of a cable harness assembler in accordance with embodiments disclosed herein.

FIG. 3 illustrates an example of counters suitable for use in the cable harness assembler illustrated in FIG. 2.

FIG. 4A illustrates an example of a coiling station suitable for use in the cable harness assembler illustrated in FIG. 2.

FIG. 4B illustrates another example of a coiling station in which a coiler may be a spool or similar structure installed so as to be removed with the cable coil thereon.

FIG. 5 illustrates an example of a coil of cables coiled at a coiling station.

FIG. 6 illustrates an example of a terminating station suitable for use in the cable harness assembler illustrated in FIG. 2.

FIG. 7 illustrates an example of a cable coil such as may be terminated at the terminating station illustrated in FIG. 6.

FIG. 8 illustrates another example of a cable harness assembler, in which a guide may be provided between source spools and counters.

FIG. 9 illustrates details of an example of the guide illustrated in FIG. 8.

### DETAILED DESCRIPTION

Embodiments are described herein that, for example, enable assembly of a cable harness to be completed in a more consistent and efficient manner than known methods of assembly, and may have notable applicability to power distribution systems of which solar power systems are an example. Other improvements and advantages, such as bettering the physical well-being of assembly personnel through improved ergonomics, also flow from the various embodiments, whether or not specifically disclosed. All such improvements and advantages are proper considered within the spirit and scope of the disclosed embodiments, without limitation.

Throughout the description, reference may be made to “electricity”, “current”, “electrical current”, “power”, “electrical power”, or the like. Although each of these terms are differentiable by one of ordinary skill in the art, for convenience, the terms are used substantially interchangeably except as noted.

In particular, a solar power system is shown as representative. Although a solar power system is illustrated, one of ordinary skill in the art will readily understand that other power systems utilizing similar components have similar issues that may be addressed by the presently disclosed embodiments. For example, electrical power generated from a fossil fuel or nuclear energy may be distributed using similar components or concepts.

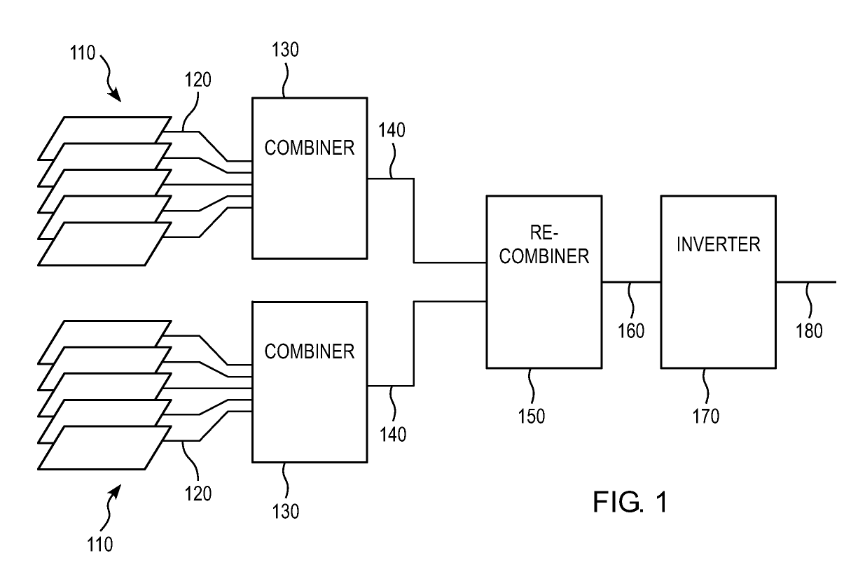

FIG. 1 illustrates an example of a solar power system 100. Solar power system 100 may include, for example, a plurality of strings 110, each comprising one PV panel or a series connection of PV panels. PV panels are sometimes referred to as PV modules, solar panels, or solar modules, to name three examples. The PV panel or panels in each string 110 may generate direct current from sunlight by the photovoltaic effect. At least some of strings 110 may be arranged in electrical parallel. Each string 110 may output direct current power from the last PV panel in the series via one or more cables 120, which provide the direct current as an input to a combiner 130. In accordance with the parallel nature of strings 110, the direct current inputs to combiner 130 may be parallel inputs. In each combiner 130, the direct current inputs may be combined into one output which is transmitted to a recombiner 150 via cables 140. Recombiner 150 may provide direct current output to an inverter 170 via a cable 160 in the illustration shown. The output of inverter 170 may be provided to a load or to a power grid, for example, via one or more cables 180.

One of ordinary skill will understand that a single combiner 130 may output directly to inverter 170, or multiple recombiners 150 may be employed, each of which may output to a re-recombiner (not shown) which in turn may provide the input to inverter 170. Intermediate components (e.g., a charge controller, not shown) may also be used. The scale of combiners and recombiners may be determined based on the size of the power distribution system and load, among other things.

In some embodiments, the inputs to combiners 130 may be direct current (DC), single-phase alternating current (AC), or three-phase AC (summed, with optional neutral) inputs via corresponding cables 120, and combined into one or more direct current outputs via cables 140.

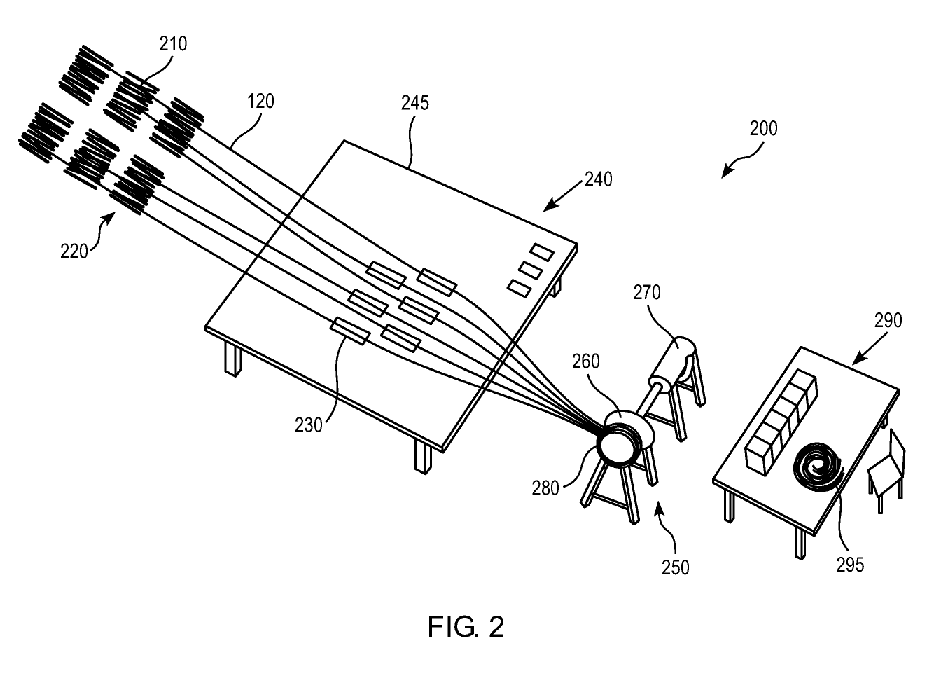

FIG. 2 illustrates one, nonlimiting example of a cable harness assembler 200 in accordance with embodiments disclosed herein. Cable harness assembler 200 may be generally useful for assembling cables used in any power distribution system. As illustrated, and without limitation, the cable harness assembler is used to produce a cable harness for a solar power distribution system such as that disclosed in FIG. 1 and, more specifically, to produce a cable harness of, e.g., cables 120 in the example shown. Throughout this specification and drawings, the cables that are illustratively processed into a cable harness will be referenced by numeral 120 as representative of cables that can be assembled into a harness, including cable 140 and other cables not mentioned.

A cable harness, as is generally known, provides a convenient way to transport heavy cables to an installation site. To this end, a cable harness may be assembled by, e.g., bundled or looping cables in a fashion permitting the cables to be carried on one's shoulder. To assemble the harness, the cables are ordinarily measured and cut to specified lengths, labeled, and bundled together as groups of cables, per specifications. After stripping the ends of the cables and crimping the exposed conductors, connectors may be applied and the bundled groups packaged in a generally circular form, on a spool or other packaging, for example. The process may be cumbersome and time-consuming, not least because the drawing, measuring, cutting, labeling, stripping, crimping, and attaching of connectors has been performed for each cable individually or in awkward and unwieldy small groups. In addition, cable harnesses comprising lengthy cables (such as some cables used in solar power systems) have been assembled by dragging the cables by hand from a cable source to the desired length, necessitating a great deal of time and effort to walk back and forth from source to desired length, whereby before or after cutting, the cables would be physically lifted to complete the harness and/or move the cables or cable harness to the desired location, all of which leads to fatigue and sometimes acute or chronic injury.

In FIG. 2, cables 120 are shown stored on source spools 210 in a supply section 220. From spools 210, one or more cables 120 may be pulled and drawn via one or more respective counters 230 toward a labeling station 240, with multiple cables being ready for labeling at the same time. Counters 230 permit the length of the drawn cables to be easily determined so that the cables can be cut simultaneously or nearly so as desired. Thus, cable harness assembler 200 not only makes drawing of a single cable 120 more convenient, but multiple cables 120 may be drawn simultaneously or nearly so if desired, or in any event presented for processing at labeling station 240 together and without tangling instead of one at a time and/or tangled. Additionally or alternatively, cables 120 may be bound together by, e.g., cable ties (not shown) at or near labeling station 240.

In some embodiments, counters 230 may be positioned on a support such as a table 245. However, one or more counters 230 may be provided on separate tables or other supports. Similarly, although labeling station 240 is shown at the end of table 245, labeling station 240 may be provided on a different support or without support, such as one or more personnel simply holding the cables while applying the labels and/or cable ties, for example.

Cables 120 may be measured and/or cut to a desired length before or after labeling. “Measuring” and “cutting” should be interpreted broadly. “Measuring”, for example, may include making an actual measurement in units (such as by counters 230), or may be an approximation of a desired length. In general, and without limitation, “measuring” may be any determination of a desired length, however precise. “Cutting”, for example, may include severing a cable of desired length from a longer cable by knife or other blade(s), or may include severing the same by heat (e.g., burning) or electromagnetic radiation. In general, and without limitation, “cutting” may be any separation of a cable of desired length from a longer cable.

Downstream of the labeling station in the assembler shown in FIG. 2, an example of a coiling station 250 is shown. In a suitable arrangement, a coiler 260 takes up cables 120, generally before cutting (although in some embodiments, cables 120 may be cut before or concurrently with spooling). Coiler 260 may take any form suitable for coiling cables 120. As shown, coiler 260 may be driven by a motor 270, which also may take any suitable form sufficient to drive coiler 260 under load. Alternatively or additionally, another power source for coiling cables 120, including human power via, e.g., a crank attached to coiler 260, may be employed. However, an advantage to the motor-driven spool is that the cables can be coiled without human intervention and/or simultaneously with attachment of labels and/or cable ties, for example. A coil 280 having the desired number of cables 120 may thus be produced. Coil 280 may be removed from coiler 260 and transported to a terminating station 290.

At terminating station 290, the cable ends may be stripped and/or terminated. Stripping a cable end includes at least exposing the conductor in the cable, whether stranded or solid. Terminating a cable may include at least joining the cable conductor to a connector to be connected at installation, for example to a PV panel, junction box (e.g., combiner or recombiner), or inverter, or to another cable, via a connector. Joining the cable conductor and connector may include crimping the connector to the conductor (at the end, for example). The connector may comprise or form part of a connector or coupler. A variety of connectors or couplers may be implemented for the terminated cables. Examples include MC3, MC4, and Tyco Solarlok® connectors. Further, any of various devices and processes for stripping and terminating cable ends may be employed to the extent suitable for the cables being prepared for the cable harness. Moreover, stripping may be performed before presenting coil 280 at terminating station 290. As illustrated in FIG. 2, a coil 295 may be the result of terminating the desired cables of coil 280.

In some embodiments, coil 280 or coil 295 may be considered a cable harness. That is, one or more cables 120 of a cable harness may be unstripped, stripped and not terminated, or terminated. Further processing of cables 120 may be performed at installation or elsewhere, for example. Moreover, coil 280 or coil 295 may be secured with cable ties or other securement (not shown).

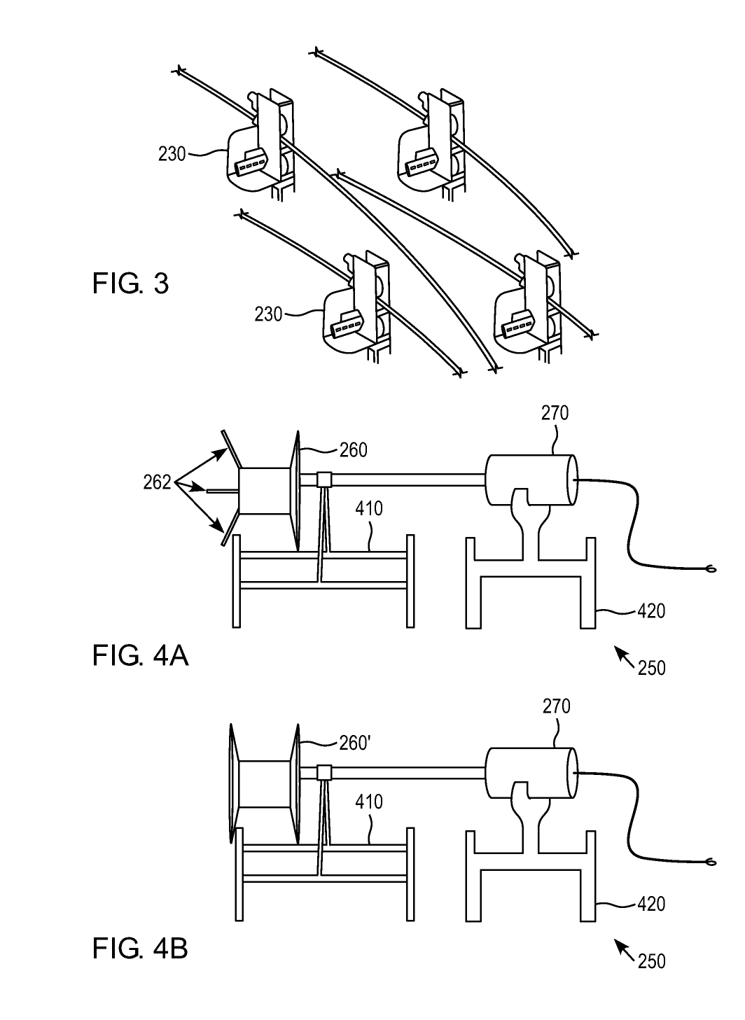

FIG. 3 illustrates an example of counters 230 suitable for use in the cable harness assembler illustrated in FIG. 2. In some embodiments, one or more of counters 230 may be positioned to receive a cable 120 being drawn by, e.g., coiler 260 and provide a numeric or other indicator of length by the drawing of the cable through or otherwise past the counter. For example, one or more counters 230 may comprise a wheel coupled to an indicator, with the cable being drawn in contact with the wheel, which may rotate by the contact and advance the indicator accordingly. Many examples of counters 230 will be readily apparent to one of ordinary skill in the art. By this arrangement, when the cable is drawn to its desired length as indicated by counter 230, the cable may be cut at the desired length. In addition, one or more of counters 230 may include pulleys (which may include the counter wheel mentioned above), grooves, or other structure to direct cables 120 toward labeling station 240 with at least reduced mutual interference or entanglement and improved distinguishability.

FIG. 4A illustrates an example of a coiling station 250 suitable for use in cable harness assembler 200. Coiling station 250 may have one or more coilers 260 supported by any suitable frame 410, although only one is shown. Furthermore, structure other than or in addition to coiler 260 for taking up cables 120 at coiling station 250 to form coil 280 may be used. Motor 270 may be supported by any suitable frame 420 and operably coupled with coiler 260, but an electric motor is not required. Rather, any suitable means for taking up cables 120 to form coil 280 may be employed. Examples may include a rotatable coiler turned by a human using a crank or foot mechanism, or a stationary coiler or other structure about which cables 120 are wound. Other examples may include a rotatable spool turned by a wheel, whether human-driven or motor-driven. Such examples are not limiting either in number or technology, or in any way other than suitability for the disclosed purpose, and many other examples will be apparent to one of ordinary skill in the art.

Coiler 260 may have spokes 262 (three are shown, without limitation) sufficient for a cable coil to be compiled without falling from coiler 260, yet being arranged so that the compiled coil may be removed from coiler 260. In another example shown in FIG. 4B, a coiler 260′ may be a spool or similar structure installed so as to be removed with the cable coil thereon. That is, according to the structure of FIG. 4A, the coil itself may be removed, whereas according to the structure of FIG. 4B, a spool on which the cable or cables are coiled may be removed.

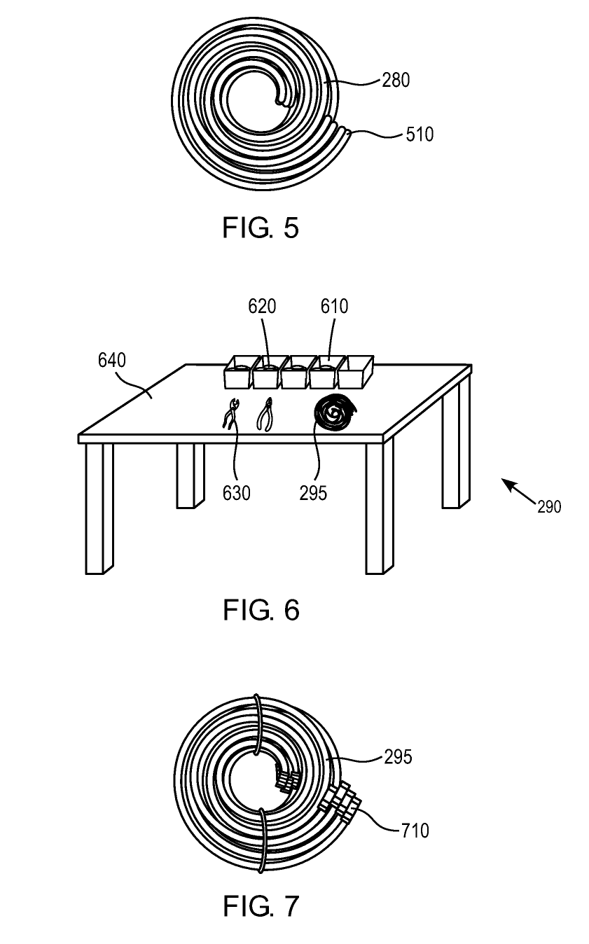

FIG. 5 illustrates an example of coil 280, which comprises cables 120 coiled at coiling station 270 illustrated in either FIG. 4A or FIG. 4B. As shown, cables 120 of coil 280 have been cut and the ends 510 ready for stripping, if desired. Cables 120 may be cut before coiling or after coiling.

FIG. 6 illustrates an example of terminating station 290 suitable for use in cable harness assembler 200. As shown, a bin 610 may hold a variety of components and/or implements 620 used with or without manual or automated tools 630 to further process cables 120 on a table 640. For example, ends 510 of cables 120 may be stripped and crimped to connectors at terminating station 290 using components/implements 620 and/or tools 630. Alternatively or in addition, ends 510 of one or all of cables 120 may be left unstripped, stripped but unterminated, or stripped and terminated (crimped and/or provided with a connector or coupler) to produce coil 295.

FIG. 7 illustrates an example of coil 295, assembled in accordance with embodiments disclosed herein. As shown in FIG. 7, the ends of cables 120 have been provided with connectors 710. Connectors 710 may be any one or more of the aforementioned connectors or couplers. Furthermore, not all ends of cables 120 need to be provided with a connector or coupler.

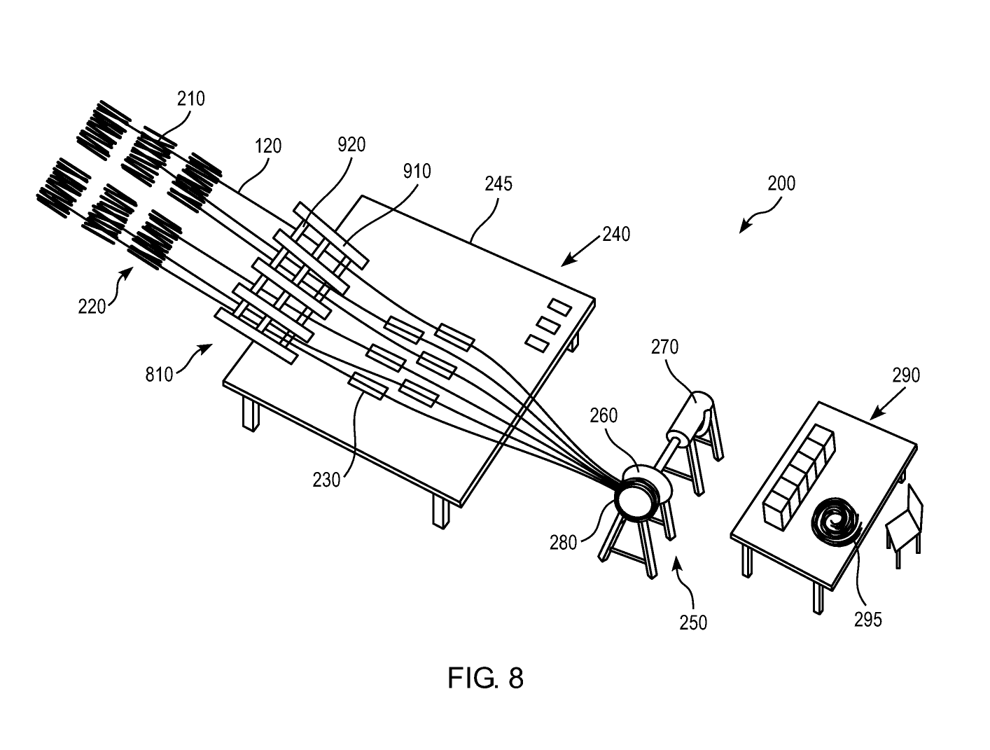

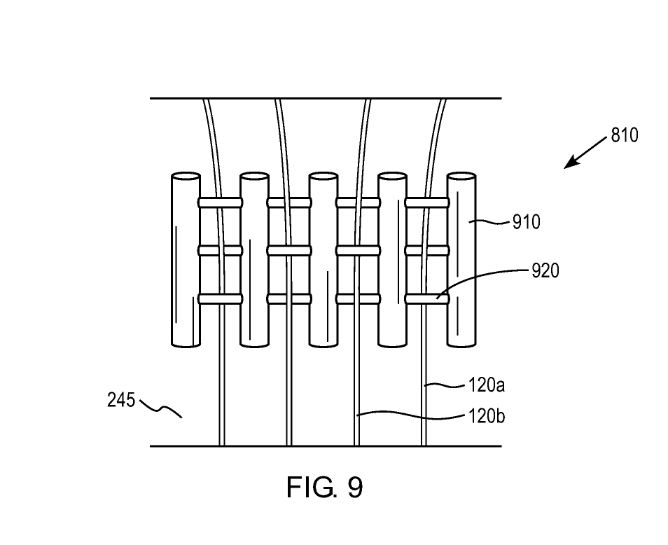

FIG. 8 illustrates an example of cable harness assembler 200 in which a guide 810 may be illustratively provided between source spools 210 and counters 230. With additional reference to an example shown in FIG. 9, guide 810 may take a form similar to a picket fence, including pickets 910 and attached rails 920. This form is merely illustrative, but useful in that the spaces formed by the crossed pickets 910 and rails 920 permit respective cables 120 to be drawn therethrough with at least reduced entanglement while enabling individual cables to be more easily distinguished.

To that end, by way of example only, cables 120a may be drawn through passages such as spaces in a “first row” of passages formed by pickets 910 and the first and second rails 920 as counted from the top of guide 810. Likewise, cables 120b may be drawn through passages in a “second row” of passages, below the first row, formed by pickets 910 and the second and third rails 920 as counted from the top of guide 810. With at least reduced entanglement, cables 120a and 120b thus may be more easily guided from supply section 220 toward labeling station 240.

Although various features, advantages, and improvements have been described in accordance with the embodiments shown, one of ordinary skill in the art will readily recognize variations and modifications to the embodiments as disclosed. All such variations and modifications that basically rely on the inventive concepts by which the art has been advanced are properly considered within the spirit and scope of the invention.

What is claimed is:

1. A method for assembling a cable harness, comprising:
pulling one or more cables from a cable source by a turning spool;
cutting each of the pulled cables at a desired length;
labeling each of the cables;
coiling the cables; and
applying a respective connector to at least one end of at least one cable in the coil.

2. The method of claim 1,
wherein the pulling and coiling of the cables include at least turning the spool to pull the cables and coil the cables around the spool.

3. The method of claim 2,
wherein the turning of the spool includes rotatably motor-driving the spool.

4. The method of claim 1, wherein pulling the cables from the cable source includes pulling one or more of the cables via a respective one or more counters which indicate a length of cable pulled.

5. The method of claim 4, wherein the cables are pulled to a labeling station; and
wherein the labeling of the cables is performed at the labeling station.

6. The method of claim 5, further comprising binding the coiled cables before the coiling.

7. A method for facilitating a solar electricity installation, comprising:
producing a cable harness, including:
pulling one or more solar power cables from a cable source by a turning spool;
cutting each of the pulled solar power cables at a desired length;
labeling each of the solar power cables;
coiling the solar power cables suitably for the cable harness; and
applying a respective connector to at least one end of at least one of the solar power cables in the coil.

8. The method of claim 7, further comprising:
transporting the cable harness to a solar electricity installation site; and
installing the solar power cables at the solar electricity installation site.

9. The method of claim 7,
wherein the pulling and coiling of the solar power cables include at least turning the spool to pull the solar power cables and coil the solar power cables around the spool.

10. The method of claim 9,
wherein the turning of the spool includes rotatably motor-driving the spool.

11. The method of claim 10, wherein pulling the solar power cables from the cable source includes pulling one or more of the solar power cables via a respective one or more counters which indicate a length of solar power cable pulled.

12. The method of claim 7, wherein the solar power cables are pulled to a labeling station; and
wherein the labeling of the solar power cables is performed at the labeling station.

13. The method of claim 12, further comprising binding the coiled solar power cables before the coiling.

14. The method of claim 13, wherein pulling the solar power cables from the cable source includes pulling one or more of the solar power cables via a respective one or more counters which indicate a length of solar power cable pulled.

15. A solar power cable harness assembler, comprising:
a solar power cable supply station;
one or more counters;
a coiling station positioned to pull the solar power cables via the one or more counters and coil the solar power cables downstream from the first and second guides in a single coil suitable for a solar power cable harness;
a cutting station positioned for cutting each of the pulled solar power cables at a desired length indicated by the one or more counters; and
a binding station before the coiling station, at which the solar power cables are bound before coiling such that the coiling station creates the single coil of the bound solar power cables.

16. The solar power cable harness assembler of claim 15, wherein the coiling station includes a spool and a motor operably connected to rotate the spool and thereby pull and coil the solar power cables around the turning spool to produce the single coil.

17. The solar power cable harness assembler of claim 16, further comprising a labeling station positioned before the coiling station at which to label the solar power cables before coiling.

18. The solar power cable harness assembler of claim 16, further comprising a terminating station at which to apply a respective connector to at least one end of at least one solar power cable in the single coil of bound solar power cables.

19. The solar power cable harness assembler of claim 15, further comprising a labeling station positioned before the coiling station at which to label the solar power cables before coiling.

20. The solar power cable harness assembler of claim 15, further comprising a terminating station at which to apply a respective connector to at least one end of at least one solar power cable in the single coil of bound solar power cables.
